(19) United States
(12) Patent Application Publication
(10) Pub. No.: US 2025/0362032 A1
(43) Pub. Date: Nov. 27, 2025

(54) ELECTRICAL INTERLOCK SYSTEM FOR KITCHEN HOODS WITH FIRE SUPPRESSION SYSTEMS

(71) Applicant: Daniel Farrington, Satellite Beach, FL (US)

(72) Inventor: Daniel Farrington, Satellite Beach, FL (US)

(21) Appl. No.: 18/674,872

(22) Filed: May 26, 2024

(51) Int. Cl. F24C 15/20; G08B 3/10; G08B 5/36; G08B 7/06; G08B 17/00; G08B 25/00

(52) U.S. Cl. CPC F24C 15/2021; G08B 3/10; G08B 5/36; G08B 25/009; G08B 7/06; G08B 17/00

(57) ABSTRACT

The Electrical Interlock System (EIS) for Kitchen Hoods provides the interconnection of the exhaust fan(s), makeup air fan(s), hood lights, power sources under the hood and building fire alarm integration in order to meet the government regulatory requirements. The EIS will have the ability to determine if the fire suppression system has been activated. In addition, the EIS will provide a single control point to turn on the exhaust fan(s), makeup air fan(s) and lighting for the kitchen hood with ability to automatically turn on based on temperature sensor. Based on these conditions, the EIS will control power to the hood system and power sources under the hood regardless of the fire suppression manufacturer, hood manufacturer, fan manufacturer and fire alarm manufacturer.

### BACKGROUND

Current Fire Safety Requirements per NFPA 17A and NFPA 96 require the following:
When the fire suppression system for the kitchen hood is activated, the Exhaust Fan (EXF) must turn on (or remain on if already on), the Makeup Air (MUA) must be turned off (and remain off), the hood lights must be turned off (and remain off) and any power outlets located under the hood must be turned off (and remain off).
When the fire suppression system is activated, an audible horn is required to activate, and the system shall stay in this state until the fire suppression system is reset.
If equipped with a building fire alarm system, the kitchen hood fire suppression system must notify the building fire alarm system of activation.
A thermal sensor shall be installed under the hood so that in the event the temperature under the hood exceeds 193 DEG F, the system shall automatically turn on.

### DETAILED DESCRIPTION

The intelligence of the Electrical Interlock System for Kitchen Hoods with Fire Suppression Systems (EIS) is the programmable microprocessor. The microprocessor is capable of monitoring various inputs and controlling the kitchen hood electrical based on the following: state of the fire suppression system, temperature under the kitchen hood and state of the start and stop controls for the system. The microprocessor can be configured to accommodate any power requirement for under hood electrical. The former way of only providing a set number of relays limits the power configuration and does not provide any customization options.

The former way of using high voltage coils with contactors wired in parallel makes maintenance of the system not only hazardous but very difficult. Furthermore, changes to the system as the power requirements under the hood change makes updates very costly and time consuming. The microprocessor combined with low voltage coils, allows the EIS to easily adapt to changes to power requirements under the kitchen hood. Contactors can be added or removed as needed with little to no programming changes to the EIS.

The former way of using high voltage wiring to control hood operation, fire suppression system status, audible alarming and fire panel notification presents many challenges in the design, installation and operation of the system due to NEC requirements. Instead, the EIS leverages the advantages of low voltage wiring controlled by a microprocessor. Using low voltage for controlling hood operations, fire suppression status monitoring, audible alarm signaling and communication to fire alarm panel reduces installation complexity and design restrictions while increasing operational safety and reliability.

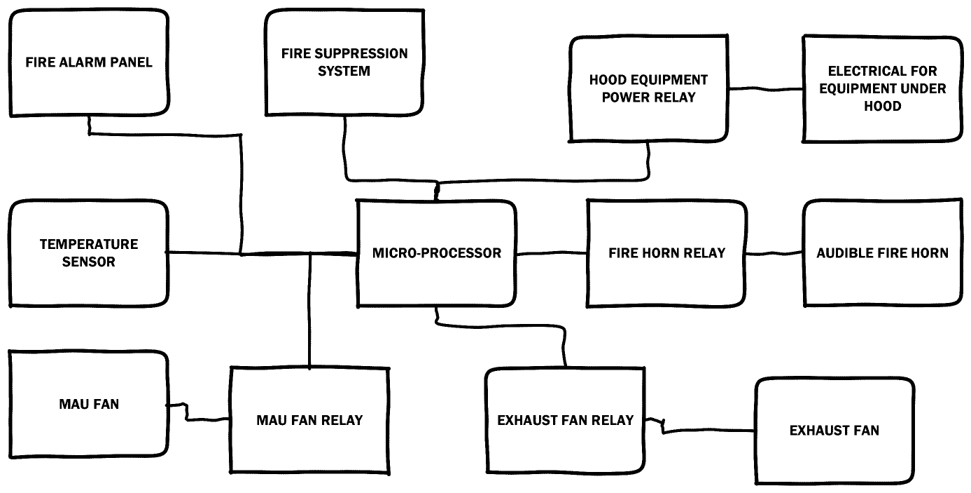

To further simplify installation, the EIS leverages a clearly labeled terminal block along the bottom of the EIS. Instead of having to wire high voltage coils and contactors in parallel, the termination block allows for quick terminations for the various fans, fire alarm panel connections, power under the hood connections and hood controls. The various features and components described herein are depicted in FIG. 1.

1. An electrical interlock system comprising:
a. A microprocessor,
b. A temperature sensor,
c. A power supply,
d. A contactor having the proper sizing for exhaust fan motor load,
e. A contactor having the proper sizing for the makeup air motor load,
f. A contactor having the proper sizing for the lighting under the hood,
g. A contactor having the proper sizing for power under the hood,
h. A horn having the proper decibel rating,
i. A relay to communicate with the fire alarm panel.

2. The electrical interlock system as claimed in claim 1, wherein the contactor for the exhaust fan will energize the exhaust fan when the fire suppression system is activated.

3. The electrical interlock system as claimed in claim 1, wherein the contactor for the makeup air fan will turn off the makeup air fan when the fire suppression system is activated.

4. The electrical interlock system as claimed in claim 1, wherein the contactor for the hood lighting will turn off the hood lighting when the fire suppression system is activated.

5. The electrical interlock system as claimed in claim 1, wherein the contactor for the power under the hood will turn off the power under the hood when the fire suppression system is activated.

6. The electrical interlock system as claimed in claim 1, wherein the relay for the audible horn will turn on the audible horn when the fire suppression system is activated.

7. The electrical interlock system as claimed in claim 1, wherein the relay for the fire alarm panel will send signal to fire alarm panel when the fire suppression system is activated.

8. The electrical interlock system as claimed in claim 1, wherein the start button will turn on the hood system when activated.

9. The electrical interlock system as claimed in claim 1, wherein the stop button will turn off the hood system when activated.

10. The electrical interlock system as claimed in claim 1, wherein the microprocessor will turn on the hood system when temperature sensor exceeds the set point.

11. The electrical interlock system as claimed in claim 1, wherein the microprocessor will keep the power under the hood on until the fire suppression system is activated.
